(19) United States
(12) Patent Application Publication
(10) Pub. No.: US 2010/0083512 A1
(43) Pub. Date: Apr. 8, 2010

(54) CHAIN SAW

(75) Inventors: Koichi SHIMOKAWA, Kawagoe-shi (JP); Buhei Kobayashi, Kawagoe-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Husqvarna Zenoah Co., Ltd., Kawagoe-shi (JP)

(21) Appl. No.: 12/245,876

(22) Filed: Oct. 6, 2008

(51) Int. Cl. B27B 17/00; F01N 7/10

(52) U.S. Cl. 30/381; 181/240; 123/41.7

(57) ABSTRACT

A muffler includes a muffler body disposed on a lower portion of an engine and a passage that extends upward from the muffler body and is opened in an upper front portion of a chain saw body. Thus, exhaust gas can be discharged forward from the chain saw body, so that exhaust sounds can be dispersed forward. Consequently, the exhaust sounds propagated to an operator can be reduced and therefore a work environment can be improved. Also, since exhaust gas is discharged after the exhaust gas passes through a long passage extending upward from the muffler body, the exhaust gas can be cooled down. Accordingly, in the chain saw body typically covered with a synthetic-resin case in which exhaust outlets are formed on positions corresponding to outlets of the passage, peripheries of the exhaust outlets can be prevented from being discolored by heat of exhaust gas.

### BACKGROUND OF THE INVENTION

1. Field of the Invention

The present invention relates to a chain saw.

2. Description of Related Art

A chain saw has been conventionally used for tree-cutting, tree-pruning, branch-trimming and the like. Such a chain saw includes a plate-shaped guide bar, a chain saw body for supporting the guide bar and housing an engine for driving a saw chain wound around the guide bar, and a handle connected to the chain saw body and gripped by an operator.

As an example of such a chain saw, a top-handle type chain saw has been known in which a handle is provided above a chain saw body (for example. Document 1: JP-A-2001-355446).

However, a muffler is opened on a lateral side of the chain saw body in such a chain saw, so that exhaust gas is discharged from the muffler to the lateral side of the chain saw body. Accordingly, exhaust sound is easily propagated to the operator when the exhaust gas is discharged, which makes difficult to provide a good work environment. Also, since a temperature of exhaust gas discharged from the muffler is high, peripheries of exhaust outlets formed on positions corresponding to openings of a muffler in a synthetic-resin case may get discolored.

### SUMMARY OF THE INVENTION

An object of the invention is to provide a chain saw capable of improving work environment and cooling exhaust gas.

A chain saw according to an aspect of the invention includes: a chain saw body having an engine transversely accommodated therein for driving a saw chain; and a top handle provided above the chain saw body, wherein the chain saw body includes a muffler for reducing exhaust noises of exhaust gas of the engine, and the muffler includes a muffler body disposed on a lower portion of the engine, and a passage that extends upward from the muffler body and is opened on an upper front portion of the chain saw body.

According to the aspect of the invention, since the passage is opened on the front portion of the chain saw body, exhaust gas can be ejected forward from the chain saw body. Accordingly, the exhaust noises can be dispersed forward, so that the exhaust noises propagated to the operator can be decreased. Thus, a work environment can be improved.

Also, since exhaust gas is discharged after the exhaust gas passes through the long passage extending upwardly from the muffler body, the exhaust gas can be cooled down. Consequently, in the chainsaw body typically covered with a synthetic-resin case in which exhaust outlets are formed on positions corresponding to outlets of the passage, peripheries of the exhaust outlets can be prevented from being discolored or deformed due to heat of exhaust gas.

Additionally, since the passage is opened in the upper front portion of the chain saw body, exhaust gas can be discharged from the upper front portion of the chain saw body. Thus, dust can be prevented from floating in the air as compared with an arrangement where exhaust gas is discharged from a lower front portion of the chain saw body.

Incidentally, the engine is “transversely” accommodated in the chain saw body such that an inclination angle α of an axis of a cylinder relative to a protruding direction of a guide bar is less than 45 degrees. As used herein, “a front portion of the chain saw body” means a side from which the guide bar of the chain saw body projects, and “forward from the chain saw body” means a protruding direction of the guide bar.

The passage may include a main passage that is communicated with the muffler body and opened on the upper front portion of the chain saw body and a sub passage that is branched from the main passage and opened at a lower position than an opening position of the main passage on the front portion of the chain saw body.

According to the aspect of the invention, the passage includes the main passage opened on the upper front portion of the chainsaw body and the sub passage opened at the lower position than the opening position of the main passage on the front portion of the chainsaw body. Since exhaust gas flows upward by nature, the exhaust gas can be discharged from the main passage in a normal state when the main passage is not clogged, and discharged from the sub passage when the main passage is clogged with dust or the like. Thus, even when the main passage is clogged with dust or the like, exhaust efficiency can be suitably maintained.

The passage and the muffler body may be communicated with each other through an ejector.

According to the above arrangement, since the passage and the muffler body are communicated with each other through the ejector, exhaust gas can be mixed with air around the ejector. Consequently, the exhaust gas can be directly and favorably cooled down. Thus, in the chainsaw body typically covered with the synthetic-resin case in which the exhaust outlets are formed on the position corresponding to the openings of the main passage and sub passage, the peripheries of the exhaust outlets can be reliably prevented from being discolored by heat of the exhaust gas.

Incidentally, the ejector includes an outlet of the muffler body and an inlet of the passage, the inlet and the outlet being disposed with a gap interposed therebetween. Exhaust gas is discharged from the outlet of the muffler body toward the inlet of the passage. At this time, a flow of the exhaust gas catches air near the gap between the outlet and the inlet and mixes the air with the exhaust gas.

The chain saw body may include a case for housing the engine and the muffler. The case may include a muffler cover that is openable and closable relative to the chain saw body for covering a lower face of the muffler body, and the muffler body may be detachable from the chain saw body when the muffler cover is detached from the chain saw body

According to the aspect of the invention, the muffler cover for covering the lower surface of the muffler body is openable and closable relative to the chain saw body, while the muffler body is detachable from the chain saw body from a lower portion of the chain saw body.

Traditionally, especially in a small-sized chainsaw, a muffler is set in a chain saw body from a lateral side and is installed to the chain saw body. Thus, when the muffler is to be detached, a large side cover that covers the lateral side of the engine, various parts mounted on the side of the engine and the like need to be detached. Replacement and maintenance of the muffler have been effort-consuming.

However, according to the aspect of the invention, the muffler body can be attached to or detached from the chain saw body by opening or closing the muffler cover, thereby facilitating replacement and maintenance of the muffler body.

### BRIEF DESCRIPTION OF THE DRAWINGS

FIG. 1 is an overall perspective view illustrating a chain saw according to an exemplary embodiment of the invention.

FIG. 2 illustrates an inside of a chain saw body according to the exemplary embodiment.

FIG. 3 is an exploded perspective view illustrating the chain saw body according to the exemplary embodiment.

FIG. 4 is a perspective view illustrating a front side of a cooling fan according to the exemplary embodiment.

FIG. 5 is a perspective view illustrating a reverse side of the cooling fan according to the exemplary embodiment.

FIG. 6 is a side view illustrating the cooling fan according to the exemplary embodiment.

FIG. 7 is a perspective view illustrating the chain saw body in cross-section of a muffler according to the exemplary embodiment.

### DETAILED DESCRIPTION OF PREFERRED EMBODIMENT(S)

### 1. Overall Arrangement of Chain Saw

An exemplary embodiment of the invention will be described below with reference to the attached drawings.

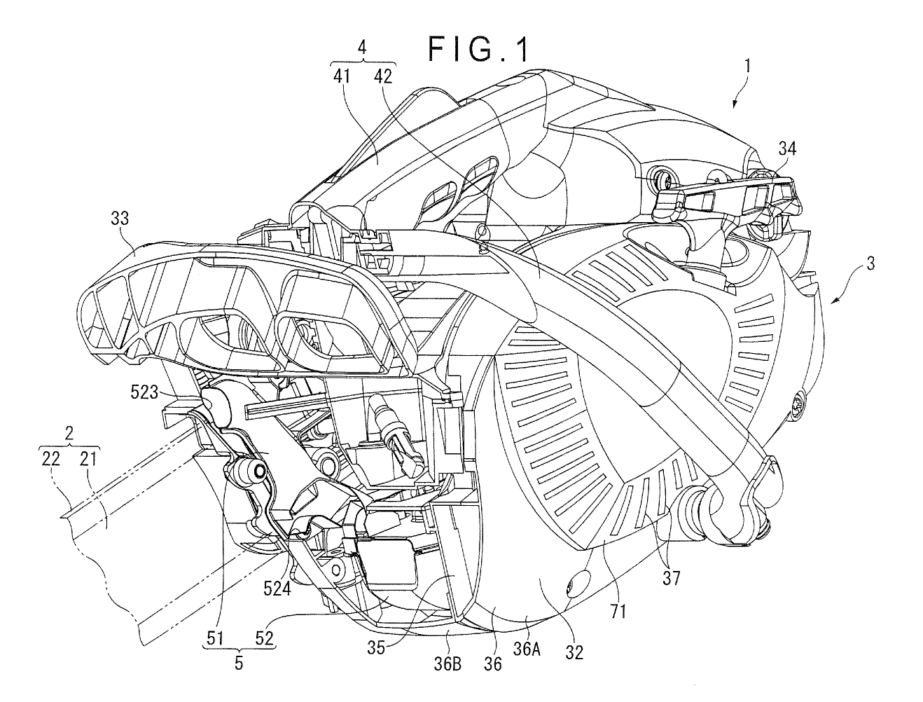

FIG. 1 is a overall perspective view illustrating a chain saw 1 according to this exemplary embodiment. In FIG. 1, a front portion of a chain saw body 3 is shown in cross section.

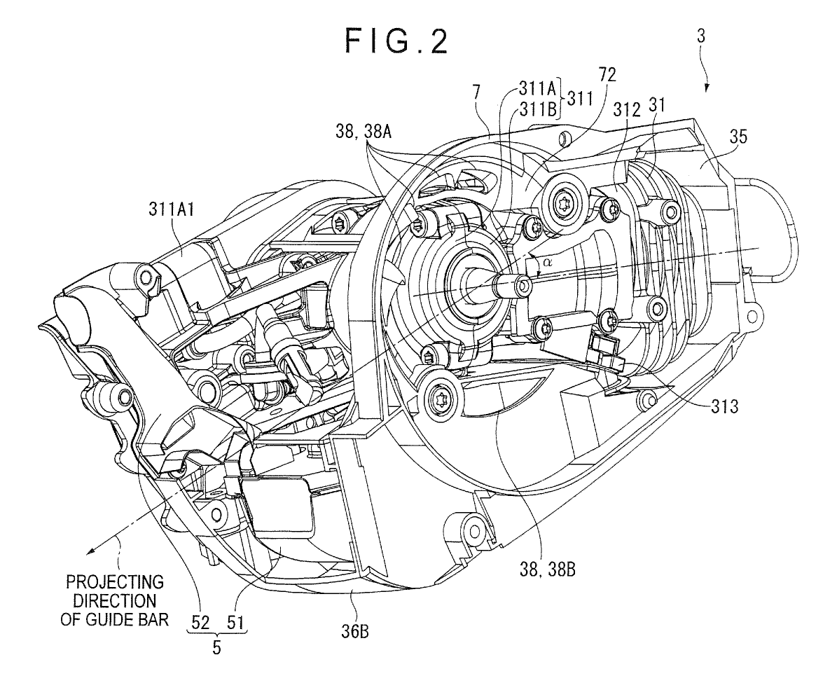

The chain saw 1 includes a chain 2, the chain saw body 3 for driving the chain 2, and a handle 4 mounted on the chain saw body 3. The chain saw 1 according to this exemplary embodiment, a detail of which will be described later, is structured as a small machine having a two-cycle engine 31 (see FIG. 2) of approximately 35 cc. Hereinafter in this description, a protruding direction of the chain 2 will be referred to as a front side, and a direction opposite thereto will be referred to as a rear side. A direction vertically perpendicular to the front-and-rear direction will be referred to as an up-and-down direction, and a direction extending horizontally perpendicular to the front-and-rear direction will be referred to as a right-and-left direction.

### 2. Arrangement of Chain and Chain Saw Body

The chain 2 includes a plate-shaped guide bar 21 and a saw chain 22 wound around the guide bar 21.

The chain saw body 3 includes an engine 31 and a synthetic-resin case 32 for housing the engine 31 and the like. A hand guard 33 is provided in an upper front portion of the chain saw body 3 while a recoil-starter handle 34 is provided on a right portion of the chain saw body 3.

### 3. Arrangement of Case

The case 32 includes a case body 35 serving as a frame in which the engine 31 and the like are installed, and a case cover 36 mounted on the case body 35 for covering the engine 31 and the like. The case cover 36 includes a right-side cover 36A mounted on a right side of the case body 35 and a muffler cover 36B mounted on a lower portion of the case body 35.

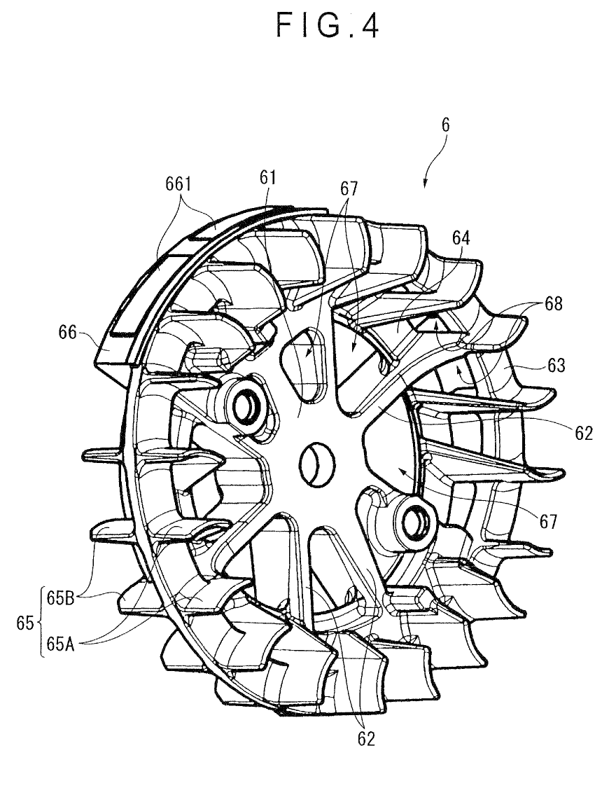

A later-described cooling fan 6 (see FIG. 4) is provided at an inner side of the right-side cover 36A. The right-side cover 36A is provided with a large number of slit-like first outer-air intakes 37 for supplying outer air to the cooling fan 6. In a front portion of the case cover 36, a main exhaust outlet (not shown) is formed at a position corresponding to a main discharge port 523 of a later-described muffler 5 while a sub exhaust outlet (not shown) is formed at a position corresponding to a sub discharge port 524 of the muffler 5.

### 4. Arrangement of Handle

The handle 4 includes a top handle 41 provided above the chain saw body 3, and a side handle 42 bridging between the top handle 41 and a lower portion of the right-side cover 36A. An operator grips the top handle 41 with his one hand while gripping the side handle 42 with the other hand for operating the chain saw 1.

### 5. Arrangement of Engine

FIG. 2 illustrates an inside of the chain saw body 3.

As shown in FIG. 2, the engine 31 is installed in the case body 35 in such a posture that the engine 31 is extended rearward and slightly downward from a crankcase 311 disposed substantially at the center of the case body 35 to a cylinder 312. In other words, the engine 31 is installed in the case body 35 in a traverse posture. Specifically, the engine 31 is accommodated in the case body 35 such that an inclination angle α between the protruding direction of the guide bar 21 and an axis of the cylinder 312 is approximately 25 degrees.

As used herein, the “traverse posture” means a posture of the engine 31 when an inclination angle α between the protruding direction of the guide bar 21 and the axis of the cylinder 312 is less than 45 degrees. In the exemplary embodiment, the engine 31 is accommodated in the case body 35 such that the inclination angle α between the protruding direction of the guide bar 21 and the axis of the cylinder 312 is 25 degrees. However, the inclination angle α is not limited thereto as long as the engine 31 is accommodated in the case body 35 such that the inclination angle α is less than 45 degrees.

As shown in FIG. 2, the crankcase 311 has a halved-structure including a front crankcase 311A and a rear crankcase 311B. The crankcase 311A on the front side (a bottom side) is integrated with a guide bar support 311A1 for supporting the guide bar 21.

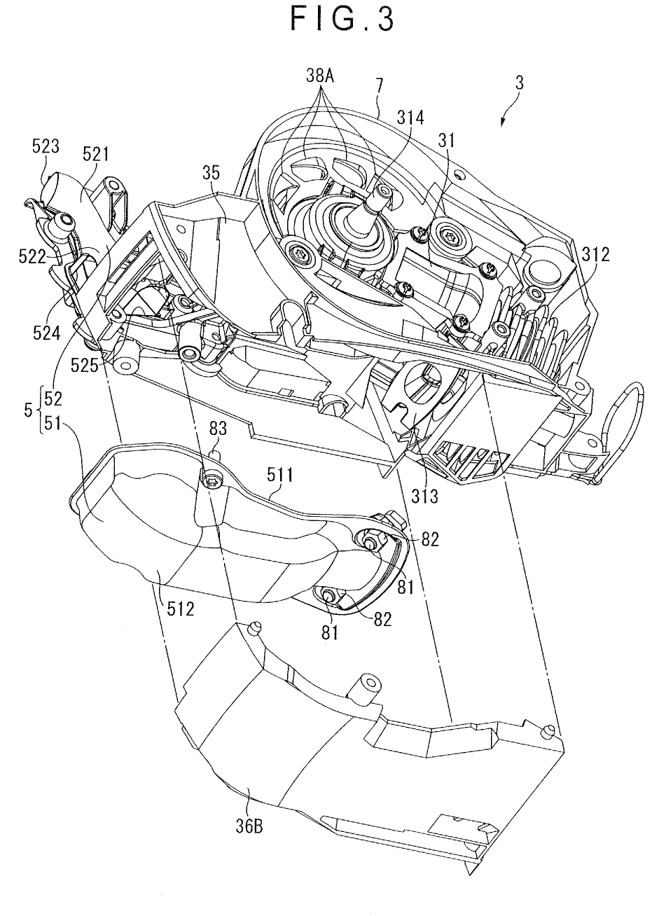

FIG. 3 is an exploded perspective view illustrating the chain saw body 3.

As shown in FIG. 3, an exhaust port 313 is provided on a lower portion of the engine 31, and the muffler 5 is mounted on the exhaust port 313. A centrifugal clutch (not shown) for driving the saw chain 22 is provided on a left end side of a crankshaft 314 of the engine 31 while the cooling fan 6 (see FIG. 4) for cooling the engine 31 is provided on a right end side of the crankshaft 314.

### 6-1. Arrangement of Cooling Fan

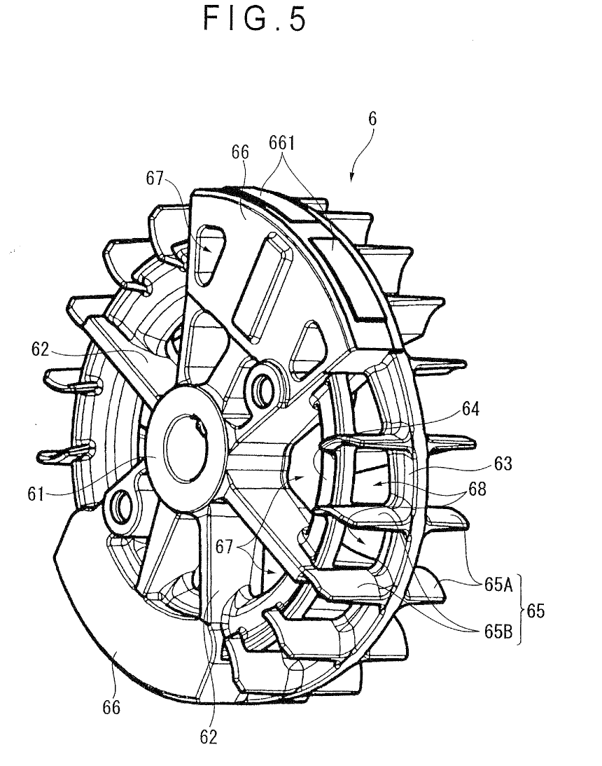

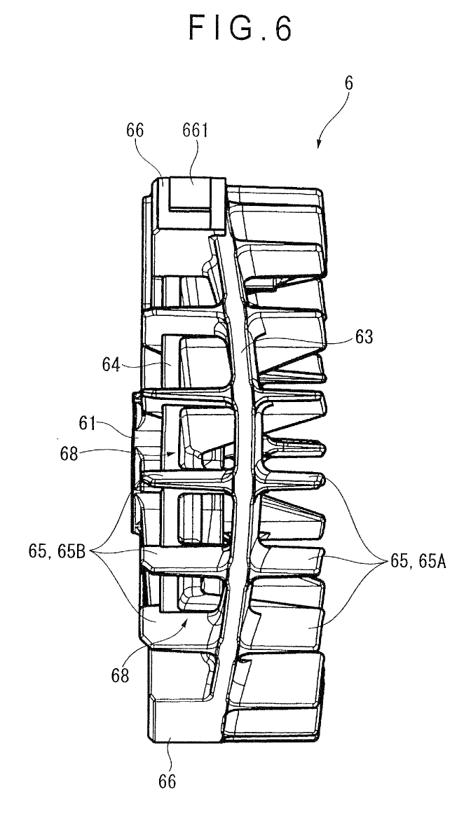

FIG. 4 is a perspective view illustrating an external side of the cooling fan 6, FIG. 5 is a perspective view illustrating an internal side of the cooling fan 6, and FIG. 6 is a side view illustrating the cooling fan 6. As used herein, the external side of the cooling fan 6 is a side not opposed to the crankcase 311 of the cooling fan 6, and the internal side of the cooling fan 6 is a side opposed to the crankcase 311 of the cooling fan 6.

As shown in FIGS. 4 to 6, the cooling fan 6 includes a hub 61 fixed to the crankshaft 314, a plurality of cooling vanes 65 provided along an outer circumference of the hub 61, and a circular first and second connectors 63 and 64 for connecting the cooling vanes 65.

The hub 61 is provided with a plurality of large through holes 67 that axially penetrate the hub 61. Since the plurality of large through holes 67 are formed on the hub 61 to bore the cooling fan 6 in the exemplary embodiment, a diameter of the cooling fan 6 can be increased without increasing a weight thereof, so that airflow of the cooling fan 6 can be increased. Incidentally, spokes 62 are provided between the through holes 67 of the hub 61.

The first connector 63 serves as a center connector according to an aspect of the invention. As shown in FIG. 6, the fist connector 63 connects between substantially central portions of the respective cooling vanes 65 in a right-and-left direction. The first connector 63 is flexed to bulge toward the external side of the cooling fan 6 while extending circumferentially between thick portions 66. Thus, a section modulus of the cooling fan 6 is increased, thereby preventing the cooling fan 6 from being flexed toward the external side by the weight of the thick portions 66 in the exemplary embodiment.

As shown in FIG. 5, the second connector 64 is disposed closer to an axially inner side than the first connector 63 and has a smaller diameter than the first connector 63. In other words, the second connector 64 is formed to be circular for circumferentially connecting inner portions of the cooling vanes 65 and the thick portions 66 in order to reinforce the cooling fan 6. Also, the second connector 64 is formed outwardly in a radial direction of the cooling fan 6 to increase inertia force of the cooling fan 6, thereby contributing to a rotation stability of the engine 31.

The cooling vanes 65 are provided as if bridging the first connector 63 and the second connector 64. Such cooling vanes 65 each include a first cooling vane 65A formed on an external side of the first connector 63 and a second cooling vane 65B formed on an internal side of the first connector 63. As shown in FIG. 5, a plurality of outer circumference holes 68 are defined by the second cooling vanes 65B, the first connector 63 and the second connector 64. Cooling air generated around roots of the second cooling vanes 65B is ejected through the outer circumference holes 68 outwardly in the radial direction of the cooling fan 6.

The pair of the thick portions 66 are provided on the internal side of the first connector 63 to face each other and interpose a central portion of the hub 61 therebetween. An ignition magnet 661 cooperated with a magnet ignition device (not shown) of the engine 31 is embedded in one of the thick portions 66.

### 6-2. Arrangement of Cooling-Fan Housing

As shown in FIG. 2, the cooling fan 6 is accommodated in a cooling-fan housing 7 including a first cover 71 (see FIG. 1) on the right-side cover 36A for covering the external side of the cooling fan 6, a second cover 72 on a case body 35 for partitioning between the cooling fan 6 and the crankcase 311 and for covering the internal side of the cooling fan 6, and a lateral side surface of the crankcase 311.

As described above, the plurality of first outer-air intakes 37 (see FIG. 1) are provided on the first cover 71. Air that flows into the cooling-fan housing 7 through the first outer-air intakes 37 is suctioned to the first cooling vanes 65A provided on the external side of the cooling fan 6 to be delivered to the cylinder 312 by the first cooling vanes 65A for cooling the cylinder 312.

As shown in FIG. 2, the second cover 72 is provided with a second outer-air intake 38. The second outer-air intake 38 includes a second upper outer-air intake 38A formed in an upper portion of the second cover 72 and a second lower outer-air intake 38B formed in a lower portion thereof.

The second upper outer-air intake 38A communicates with an upper space of the chain saw body 3 for supplying air delivered from the upper side of the crankcase 311 to the inner side of the cooling fan 6. On the other hand, the second lower outer-air intake 38B communicates with a lower space of the chain saw body 3 for supplying relatively cooled air to the inner side of the cooling fan 6. In this exemplary embodiment, a larger amount of air is supplied to the cooling fan 6 through the second lower outer-air intake 38B than through the second upper outer-air intake 38A. The second lower outer-air intake 38B serves as a main outer-air intake of the second outer-air intakes 38. These second outer-air intakes 38A and 38B supply outer air to the cooling fan 6 by taking in the outer air through outer-air inlets (not shown) formed in the case cover 36.

Air that flows into the cooling-fan housing 7 through the second outer-air intakes 38A and 38B is suctioned by the second cooling vanes 65B formed on the inner side of the cooling fan 6 to be delivered to the cylinder 312 by the second cooling vanes 65B for cooling the cylinder 312.

Traditionally, outer-air inlets for supplying air to cooling vanes provided on an external side and an internal side of a cooling fan are easily clogged with a large amount of dust generated during operation. Once some of the outer-air inlets are clogged, air cannot be delivered by the cooling vanes provided adjacent to the clogged outer-air inlets, so that air flow to a cylinder is unfavorably reduced.

In contrast, in the chain saw 1 of the exemplary embodiment, the cooling fan 6 is provided with the through holes 67. With this arrangement, even when some of the outer-air intake 37 or 38 is clogged with dust, the cooling vanes 65A or 65B adjacent to the clogged outer-air intake 37 or 38 can breathe from the unclogged outer-air intake 37 or 38 through the through holes 67. Accordingly, even when the outer-air intake 37 or 38 is clogged, reduction in the air flow supplied to the cylinder 312 can be suppressed.

In addition, since the cooling vanes 65A and 65B are provided on both side of the cooling fan 6 in the exemplary embodiment, the cooling vanes 65A or 65B adjacent to the uncloggcd outer-air intake 37 or 38 can deliver air directly from the unclogged outer-air intake 37 or 38 without using the through holes 67.

As compared with an arrangement where the cooling vanes 65 are provided only adjacent to the clogged outer-air intake 37 or 38, air intake efficiency of the cooling fan 6 can be enhanced in the exemplary embodiment all the more because the cooling vanes 65A or 65B adjacent to the unclogged outer-air intake 37 or 38 can deliver air directly from the unclogged outer-air intake 37 or 38 without using through though holes 67. Thus, reduction in air flow due to clogging of outer-air intakes can be further suppressed.

### 7-1. Overall Arrangement of Muffler

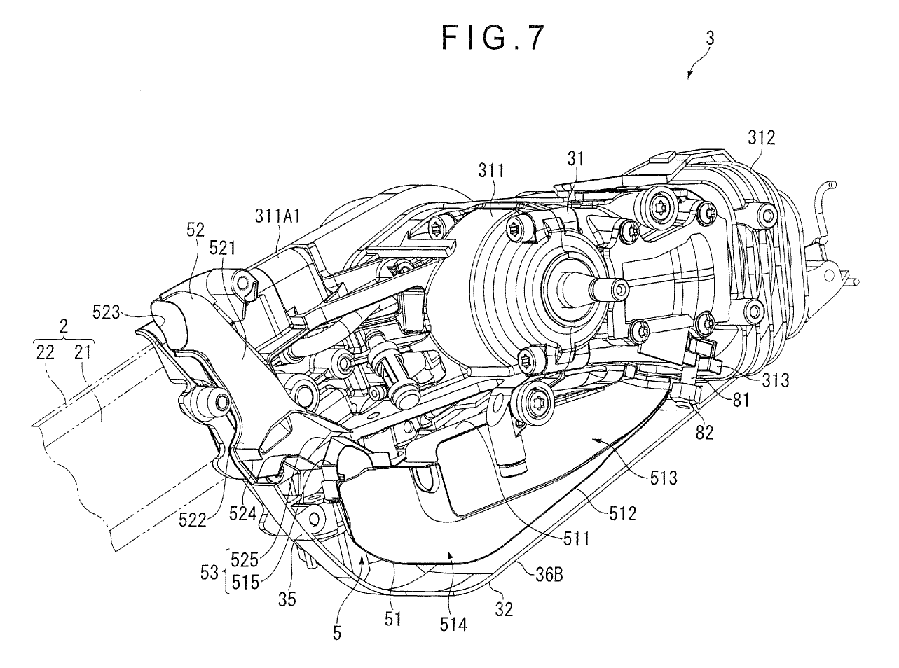

FIG. 7 is a perspective view illustrating the chain saw body 3 in cross-section of the muffler 5.

As shown in FIGS. 3 and 7, the muffler 5 includes a muffler body 51 connected to the engine 31 and a passage 52 mounted on a guide bar support 311A1 and communicated with the muffle body 51.

### 7-2. Arrangement of Muffler Body

As shown in FIGS. 3 and 7, the muffler body 51 is accommodated in a space of the chain saw body 3 extending from the lower side toward the front side of the engine 31. The muffler body 51 has a box-shape and includes an upper face 511 inclined at the approximately same angle as the inclination angle α of the cylinder 312 and a lower face 512 shaped to follow the inner face of the muffler cover 36B. Two muffling chambers 513 and 514 are provided within the muffler body 51. An outlet 515 is provided on a front portion of the upper face 511.

A rear portion of the muffler body 51 is penetrated by a pair of bolts 81 protruding downwardly from the exhaust port 313. The pair of bolts 81 are respectively screwed with a nut 82 so that the rear portion of the muffler body 51 is fixed to the exhaust port 313. Also, a front portion of the muffler body 51 is penetrated by a pair of bolts 83 inserted upwardly. Then, the pair of bolts 83 are screwed with the crankcase 311 so that the front portion of the muffler body 51 is fixed to the crankcase 311. In other words, the muffler body 51 of the exemplary embodiment is attachable to/detachable from the chain saw body 3 from a lower side of the chain saw body 3. The muffler body 51 is covered with the muffler cover 36B. The muffler cover 36B is detachable from the case body 35. The muffler cover 36B is sufficiently large so that the muffler body 51 is attached or detached to the chain saw body 3 when the muffler cover 36B is detached.

Traditionally, especially in a small-sized chain saw, a muffler is set in a case body from a lateral side in order to be installed in the case body and an engine. When the muffler is attached or detached, a large side cover that covers a side of the engine, various parts mounted on the side of the engine and the like need to be detached. Thus, replacement and maintenance of the muffler have been effort-consuming.

In contrast, in the chain saw 1 of the exemplary embodiment, a portion for covering the muffler body 51 is separately detachable as the muffler cover 36B while the muffler body 51 is detachable from the lower side of the chain saw body 3. Thus, the muffler body 51 can be attached to or detached from the chain saw body 3 only by detaching the muffler cover 36B, thereby facilitating replacement and maintenance of the muffler body 51.

### 7-3. Arrangement of Passage

The passage 52 is used for ejecting exhaust gas passing through the muffler body 51 to the outside of the chain saw body 3. As shown in FIG. 7, the passage 52 includes a main passage 521 that extends upwardly from a front portion of the muffler body 51 and is opened in the front upper portion of the chain saw body 3, and a sub passage 522 that is branched from the main passage 521 and is opened in a front lower portion of the chain saw body 3.

Specifically, the main passage 521 is opened upwardly adjacent to a root of a protruding portion of the guide bar 21 from the chain saw body 3 on the front side of the chain saw body 3, and the sub passage 522 is opened downwardly adjacent to the root of the protruding portion of the guide bar 21. An aperture opened forward in the main passage 521 serves as a main discharge port 523 of the passage 52, and an aperture opened forward in the sub passage 522 serves as the sub discharge port 524 of the passage 52.

The passage 52 and the muffler body 51 are communicated with each other through an ejector 53. In other words, a small gap is formed between an inlet 525 opened at a root of the passage 52 and an outlet 515 of the muffler body 51. The passage 52 and the muffler body 51 are communicated with each other through the ejector 53 including the inlet 525 and the outlet 515 which are disposed opposite to each other while interposing the gap therebetween.

### 7-4. Flow of Exhaust Gas

A How of exhaust gas ejected from the engine 31 will be described below.

Exhaust gas ejected from the engine 31 passes through the muffling chambers 513 and 514 in the muffler body 51 for muffling, and then is delivered to the inlet 525 of the main passage 521 from the outlet 515. At this time, a flow of the exhaust gas catches cooling air around the ejector 53 from the gap between the outlet 515 and the inlet 525 to mix the cooling air with the exhaust gas.

Since exhaust gas flows upwardly by nature, the exhaust gas flown into the main passage 521 as described above usually passes through the main passage 521, and is discharged forward from the main discharge port 523. Subsequently, the exhaust gas passes through a main exhaust outlet (not shown) formed in the case cover 36 to be ejected forward to the outside of the chain saw body 3. On the other hand, when the main discharge port 523 is clogged by a large amount of powder dust and the like generated during operation, the exhaust gas drawn into the main passage 521 is delivered to the sub passage 522 at the branch and then is ejected forward from the sub discharge port 524 that is opened in the front lower portion of the chain saw body 3. Subsequently, the exhaust gas passes through a sub exhaust outlet (not shown) formed in the case cover 36 to be ejected forward to the outside of the chain saw body 3.

Since the discharge ports 523 and 524 of the passage 52 are formed on the front side of the chain saw body 3 in the chain saw 1 of the exemplary embodiment, exhaust gas can be ejected forward from the chain saw body 3. Accordingly, an exhaust sound can be dispersed forward, so that the exhaust sound propagated to the operator can be decreased. Thus, a work environment can be improved.

Additionally, exhaust gas is usually discharged to the outside after the exhaust gas passes through the main passage 521 extending upward from the muffler body 51, so that the exhaust gas can be cooled. Thus, a periphery of the main exhaust outlet formed on the synthetic-resin case cover 36 can be prevented from being discolored or deformed by heat of the exhaust gas.

further, since the passage 52 and the muffler body 51 are communicated with each other through the ejector 53, exhaust gas can be mixed with cooling air around the ejector 53. Consequently, the exhaust gas can be directly and favorably cooled down. Thus, the peripheries of the main exhaust outlet and the sub exhaust outlet formed on the case cover 36 can be steadily prevented from being discolored or deformed by heat of the exhaust gas.

Further, since the main discharge port 523 of the passage 52 is disposed upwardly adjacent to the root of the protruding portion of the guide bar 21 and exhaust gas is usually discharged from proximity of the upper portion at the root of the protruding portion of the guide bar 21, powder dust flying up due to drive of the saw chain 22 can be prevented as compared with an arrangement where exhaust gas is discharged from proximity of the lower portion at the root of the guide bar 21.

Furthermore, since the passage 52 includes the sub passage 522, even when the main discharge port 523 is clogged by powder dust or the like, exhaust gas can be discharged from the sub discharge port 524. Thus, even when the main discharge port 523 is clogged, exhaust efficiency can be suitably maintained. Also, since the exhaust gas can be discharged from the sub exhaust hole 524, the exhaust gas can be prevented from flowing back into the chain saw body 3 from the gap of the ejector 53.

### 8. Modification of the Exemplary Embodiment

It should be noted that the best arrangement, method and the like for carrying out the invention have been disclosed in the above description but the scope of the invention is not limited thereto. In other words, while the invention has been particularly illustrated and described with reference to the specific embodiment, those skilled in the art may make various modifications to the above-described embodiment in terms of shapes, quantities and other details without departing from the spirit and the scope of the invention.

Thus, the above-disclosed shapes, quantities and the like are merely exemplarily described for easy understanding of the invention, so that the invention is not limited thereto. The invention shall include a description using names of components without a part or all of the limitation on the shapes, quantities and the like.

For example, the muffler body 51 and the passage 52 are spaced from each other and are not integrated with each other in the exemplary embodiment. However, the muffler body 51 and the passage 52 may be integrated. Also, the sub passage 522 may not be provided.

Though the muffler cover 36B is detachable from the case body 3 in the exemplary embodiment, the muffler cover 36B may not be detachable as long as the muffler cover 36B is openable and closable. Tn other words, it is only necessary that the muffler cover be openable and closable such that the muffler body 51 can be attached to or detached from the chain saw body 3 when the muffler cover is opened.

The Japanese application Number JP2007-181171 upon which this patent application is based is hereby incorporated by reference.

What is claimed is:

1. A chain saw, comprising:
a chain saw body including an engine transversely accommodated therein for driving a saw chain; and
a top handle provided above the chain saw body, wherein
the chain saw body includes a muffler for reducing exhaust noises of exhaust gas of the engine, and
the muffler includes a muffler body disposed on a lower portion of the engine, and a passage that extends upward from the muffler body and is opened on an upper front portion of the chain saw body.

2. The chain saw according to claim 1, wherein
the passage includes a main passage that is communicated with the muffler body and opened on the upper front portion of the chain saw body and a sub passage that is branched from the main passage and opened at a lower position than an opening position of the main passage on a front portion of the chain saw body.

3. The chain saw according to claim 1, wherein
the passage and the muffler body are communicated with each other through an ejector.

4. The chain saw according to claim 2, wherein
the passage and the muffler body are communicated with each other through an ejector.

5. The chain saw according to claim 3, wherein
the chain saw body includes a case for housing the engine and the muffler,
the case includes a muffler cover that is openable and closable relative to the chain saw body for covering a lower face of the muffler body, and
the muffler body is detachable from the chain saw body when the muffler cover is detached from the chain saw body.

6. The chain saw according to claim 4, wherein
the chain saw body includes a case for housing the engine and the muffler,
the case includes a muffler cover that is openable and closable relative to the chain saw body for covering a lower face of the muffler body, and
the muffler body is detachable from the chain saw body when the muffler cover is detached from the chain saw body.
